(19) United States
(12) Patent Application Publication
(10) Pub. No.: US 2026/0301271 A1
(43) Pub. Date: Oct. 1, 2026

(54) METHOD, APPARATUS, DEVICE, MEDIUM, AND PRODUCT FOR PREVIEWING DIGITAL CONTENT

(71) Applicants: Bytedance Technology Ltd., Grand Cayman (KY); Beijing Zitiao Network Technology Co., Ltd., Beijing (CN)

(72) Inventors: Pei Zhou, Beijing (CN); Shiying Wang, Beijing (CN)

(21) Appl. No.: 19/631,437

(22) Filed: Mar. 27, 2026

(30) Foreign Application Priority Data
Mar. 31, 2025 (CN) 202510399852.0

(51) Int. Cl. G06T 11/60; G06F 3/04845

(52) U.S. Cl. CPC G06T 11/60; G06F 3/04845

(57) ABSTRACT

The present disclosure relates to a method for previewing digital content. The method includes: displaying a digital content in an editing interface of the digital content; selecting a first material from a material library, the first material not having been applied to the digital content; and in response to the selecting, displaying, in the editing page, a first preview effect of the digital content with the first material applied.

### CROSS-REFERENCE TO RELATED APPLICATION(S)

The present application claims priority to Chinese Patent Application No. 202510399852.0, filed on Mar. 31, 2025, and entitled “METHOD, APPARATUS, DEVICE, MEDIUM, AND PRODUCT FOR PREVIEWING DIGITAL CONTENT”, which is incorporated herein by reference in its entirety.

### FIELD

The present disclosure relates to the field of computers, and more specifically, to a method, an apparatus, a computing device, a computer storage medium, and a computer program product for previewing digital content.

### BACKGROUND

In a digital content creation process, a user typically performs core editing and creation in an environment that is referred to as a main editing scene. The main editing scene includes all main content (such as a picture, a video, and a 3D model) that the user is currently operating on and related settings (such as illumination, a material, and a geometric layout). During creation process, the user often needs to use certain materials, for example, by selecting digital materials (such as a picture, a video, and a 3D model) from a material library, adding them to the digital content in the main editing scene, and observing a collocation effect. If the user is not satisfied, the user manually deletes the material from the data content. This operation mode is quite inconvenient and may cause confusion in version management.

### SUMMARY

In a first aspect of embodiments of the present disclosure, a method for previewing digital content is provided. The method includes: displaying a digital content in an editing interface of the digital content; selecting a first material from a material library, the first material not having been applied to the digital content; and in response to the selecting, displaying, in the editing interface, a first preview effect of the digital content with the first material applied.

In a second aspect of embodiments of the present disclosure, an apparatus for previewing digital content is provided. The apparatus includes: a displaying unit configured to display a digital content in an editing interface of the digital content; a selecting unit configured to select a first material from a material library, the first material not having been applied to the digital content; and the displaying unit is further configured to display, in response to the selecting and in the editing interface, a first preview effect of the digital content with the first material applied.

In a third aspect of embodiments of the present disclosure, an electronic device is provided. The electronic device includes: at least one processing unit; and at least one memory, the at least one memory is coupled to the at least one processing unit, and stores instructions executable by the at least one processing unit, the instructions, when executed by the at least one processing unit, causes the electronic device to perform the method according to the first aspect of the present disclosure.

In a fourth aspect of embodiments of the present disclosure, a non-transitory computer storage medium is provided. The non-transitory computer storage medium includes machine-executable instructions, the machine-executable instructions, when executed by a device, causes the device to perform the method according to the first aspect of the present disclosure.

In a fifth aspect of embodiments of the present disclosure, a computer program product is provided. The computer program product includes machine-executable instructions, the machine-executable instructions, when executed by a device, causes the device to perform the method according to the first aspect of the present disclosure.

The Summary section is provided to introduce a selection of concepts in a simplified form, which will be further described in the Detailed Description section below. The Summary section is not intended to identify key features or essential features of the claimed subject matter, nor is it intended to limit the scope of the claimed subject matter.

### BRIEF DESCRIPTION OF THE DRAWINGS

The above and other features, advantages, and aspects of embodiments of the present disclosure will become more apparent in combination with the drawings and with reference to the following detailed description. Among them:

FIG. 1A shows a schematic diagram of an editing interface displaying digital content according to some embodiments of the present disclosure;

FIG. 1B shows a schematic diagram of an editing interface displaying a preview effect of digital content according to some embodiments of the present disclosure;

FIG. 2 shows a flowchart of a method for previewing digital content according to some embodiments of the present disclosure;

FIG. 3 shows a flowchart of a method for rendering and generating a preview effect according to some embodiments of the present disclosure;

FIG. 4 shows a block diagram of an apparatus for previewing digital content according to some embodiments of the present disclosure; and

FIG. 5 shows a block diagram of a device capable of implementing multiple embodiments of the present disclosure.

Throughout the drawings, the same or similar reference numbers refer to the same or similar elements.

### DETAILED DESCRIPTION

It should be understood that all user-related data involved in the technical solution should be acquired and used after user authorization. This means that in the technical solution, if user personal information needs to be used, explicit user consent and authorization are required before the data is acquired, otherwise, related data collection and use will not be performed. It should also be understood that when implementing the technical solution, relevant laws and regulations should be strictly complied with in a data collection, use, and storage process, and necessary technical means and measures should be taken to ensure user data security and secure data use.

It should be understood that before the technical solutions disclosed in embodiments of the present disclosure are used, users should be informed of the type, range of use, use scenarios, etc., of personal information involved in the present disclosure in an appropriate manner in accordance with relevant laws and regulations, and user authorization should be obtained.

For example, when a user's active request is received, prompt information is sent to the user to clearly prompt the user that the requested operation will require access to and use of the user's personal information. As such, the user may independently choose, based on the prompt information, whether to provide the personal information to software or hardware, such as an electronic device, an application, a server, or a storage medium, that performs operations of the technical solution of the present disclosure.

As an optional but non-limiting implementation, in response to receiving the user's active request, the prompt information may be sent to the user in the form of, for example, a pop-up window, in which the prompt information may be presented in text. Furthermore, the pop-up window may also include a selection control for the user to select whether to “agree” or “disagree” to provide the personal information to the electronic device.

It should be understood that the above process of notifying and obtaining user authorization is only illustrative and does not limit the implementations of the present disclosure. Other methods that satisfy relevant laws and regulations may also be applied in the implementations of the present disclosure.

Hereinafter, embodiments of the present disclosure will be described in more detail with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only used for illustrative purposes, rather than limiting the protection scope of the present disclosure.

In the description of the embodiments of the present disclosure, the term “include/comprise” and similar terms should be understood as open-ended inclusions, that is, “include/comprise but not limited to”. The term “based on” should be understood as “based at least in part on”. The term “one embodiment” or “the embodiment” should be understood as “at least one embodiment”. The terms “first”, “second”, etc. may refer to different or same objects, unless explicitly stated. Other explicit and implicit definitions may also be included below.

As mentioned above, in the digital content creation process, the user often needs to select a material from the material library and apply it to the main editing scene to observe whether it is suitable for the current main editing scene effect. If it is not suitable or the user is not satisfied, the user needs to perform cumbersome manual restoration or undo operations. In addition to the cumbersome operations, the problem with this operation mode is that it directly modifies the main editing scene, which may lead to data pollution or performance issues. For example, the main editing scene may be affected by this operation, resulting in unnecessary modifications. In addition, adding and applying materials to the main editing scene may lead to frequent loading and rendering operations, reducing editing performance. Therefore, there is a need to design a new digital content preview method without modification to the main editing scene.

To this end, the present disclosure provides a method for previewing digital content. In this method, the digital content is displayed in an editing interface of the digital content. According to the method, a user may select a material that has not been applied to the digital content from a material library, expecting to preview a preview effect of the material combined with the digital content. In response to the user's selection, a preview effect of the digital content applied with the user-selected material applied is displayed in the editing interface.

In some embodiments, the digital content may include materials (for example, effects, filters, etc.) applied to original audio and video content, which are referred to as applied materials for short. The applied materials may be considered as components of the current digital content. Optionally, the digital content may also include only the original content without the applied materials. In some implementations, the applied materials belonging to the digital content may be viewed on a resource panel of the editing environment.

Through the embodiments of the present disclosure, the user may be helped to select a material and preview a preview display effect of the material applied to a preview of the digital content in real time without affecting the digital content in the main editing scene, thereby helping the user determine whether to select the material and apply it to the digital content.

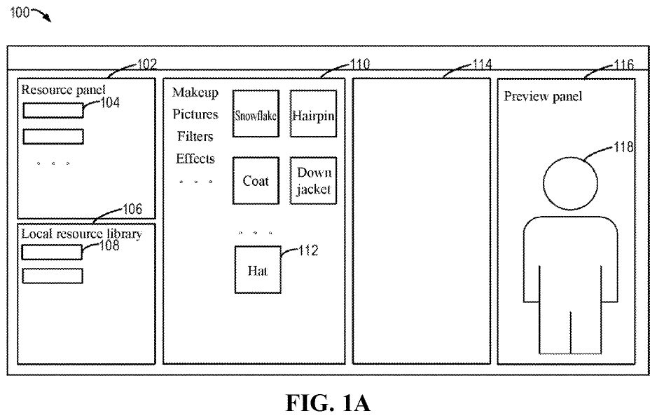

FIG. 1A shows a schematic diagram of an editing interface 100 displaying digital content according to some embodiments of the present disclosure. A device that may be used to display the editing interface 100 may include a terminal device, and the terminal device may be an electronic device with data processing and display functions, including but not limited to, a mobile phone, a tablet computer, a wearable device, a vehicle-mounted device, an augmented reality/virtual reality device, a notebook computer, an ultra-mobile personal computer, a netbook, a personal digital assistant, an Internet of Things device, an industrial terminal, and various electronic devices with an interface display function. The embodiments of the present disclosure do not impose any limitations on the specific type of the electronic device. Digital content refers to various information and resources created, stored, transmitted, and used in a digital form, covering text, images, audio, video, 3D models, animation, software applications, etc.

As shown in the figure, the exemplary editing interface 100 includes a resource panel 102, a local resource library panel 106, a material library panel 110, a main editing scene panel 114, and a preview panel 116. It should be understood that the layout of the editing interface 100 is only exemplary, some of the panels may be omitted, or the editing interface 100 may include more panels.

The resource panel 102 is used to present applied materials 104 of the digital content that is currently being created. The applied materials 104 represent materials that the user may directly operate on, manage, or modify in the editing scene 100. The applied materials 104 may include filters, effects, stickers, etc. The user may click on a certain material in the resource panel, and edit or adjust parameters of the material in the main editing scene panel 114. Optionally, the resource panel 102 may not include the applied materials 104, that is, the current digital content only includes original audio and video content.

The editing interface 100 further includes a local resource library 106, and the local resource library 106 includes resources 108 of materials stored locally. The applied materials in the resource panel 102 may be linked to corresponding resources in the local resource library. In some embodiments, when the user edits the applied materials 104 in the resource panel 102, an edit operation is performed on the resources 108 to which they are linked. Optionally, the local resources 108 may also be edited to cause the materials connected to the resources to change.

The editing interface 100 further includes a material library 110, and the material library 110 may include one or more materials that have not been applied to the current digital content (that is, not added to the resource panel). Exemplarily, the material library 110 may include multiple different material categories, for example, makeup, pictures, filters, effects, and more different material categories. In some embodiments, multiple different materials may be included under different material categories. Exemplarily, when one material category (for example, effects) is selected from multiple different material categories, multiple different materials included under the material may be displayed, for example, a snow effect, a wearing hairpin effect, a wearing coat effect, a wearing down jacket effect, and a wearing hat effect 112. It should be understood that the above examples are only illustrative, and the material library 110 may include more material categories and more material content.

The editing interface 100 further includes a main editing scene panel 114. The main editing scene panel 114 provides an editable interface obtained based on the applied materials of the digital content. For example, the main editing scene panel 114 may display a three-dimensional perspective effect of materials such as illumination conditions, three-dimensional objects, and textures combined together. In some embodiments, the main editing scene panel 114 may also provide an interactive element for adjusting parameters of the applied materials.

The editing interface 100 further includes a preview panel 116. The preview panel 116 may display a preview 118 of the digital content that is currently being edited, such as a portrait. Specifically, based on the applied materials of the digital content, a rendered image or video 118 of the digital content is displayed in the preview panel 116. It should be noted that the preview 118 generated based on the applied materials of the digital content and the main editing scene panel 114 run in isolation from each other, for example, using independent memory resources without interfering with each other.

FIG. 1B shows a schematic diagram of an editing interface 100 displaying a preview effect of digital content according to some embodiments of the present disclosure. In FIG. 1B, the preview panel 116 presents a preview 120 applied with a wearing hat effect 112.

Specifically, the user selects a material (referred to as a first material for ease of understanding and description) from the material library 110, for example, the wearing hat effect 112. By applying the first material on the preview 118 of the digital content, a preview effect of the first material combined with the applied materials of the digital content is displayed. Exemplarily, by applying the wearing hat effect on the preview 118 of the digital content, a preview effect of the portrait wearing the hat (referred to as a first preview effect for ease of understanding and description) is displayed.

If the user performs a touch (click or tap) on a blank area of the editing interface 100 for the digital content, the preview of the digital content may be restored for display. After the wearing hat effect is applied on the preview 118 of the digital content, the preview 120 of the portrait's preview 118 wearing the hat is displayed in the preview panel 116. The touch on the blank area of the editing interface 100 for the digital content is received, and the preview 118 of the portrait is restored for display. That is, when the blank area of the editing interface 100 is clicked, the preview 120 of the portrait wearing the hat is canceled for display, and the preview 118 of the portrait in FIG. 1A is restored for display.

After previewing the first material, the user may re-select a second material that has not been applied to the digital content from the material library, and view a preview effect after the second material is added. Exemplarily, the second material may be applied on the preview 118 of the digital content to replace the first material, and a second preview effect of the second material combined with the applied materials of the digital content is displayed. For example, the second material may be a wearing down jacket effect, in which case the wearing hat effect in the preview 120 of the portrait wearing the hat is canceled for display, and the down jacket effect is applied on the portrait preview 118 to display a preview effect of the portrait wearing the down jacket.

In FIG. 1B, the editing interface 100 further includes a control 122. The control 122 is configured to receive a user's interactive operation of selecting a material that is currently being previewed. In some embodiments, when the first material is being previewed (that is, when the preview panel 116 presents the preview effect of the first material combined with the digital content), the first material is applied to the digital content in response to the user's touch on the control 122. In other words, through an input to the control 122, the user confirms that the first material matches the current digital content, thereby applying the first material to the digital content. Correspondingly, the first material may be added to the resource panel 102.

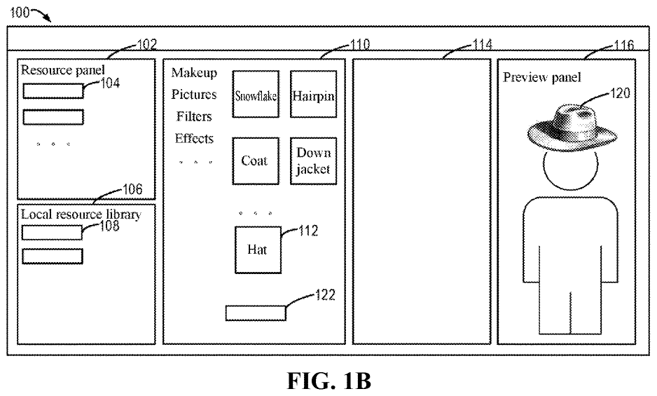

FIG. 2 shows a flowchart of a method 200 for previewing digital content according to some embodiments of the present disclosure. The method 200 may be performed by a terminal device.

As shown in FIG. 2, at block 202, display a digital content in an editing interface of the digital content. Referring to FIG. 1A, the terminal device may display the digital content in a preview panel 116 in an editing interface 100 of the digital content. In some embodiments, a rendered image or video 118 of the digital content may be displayed in the preview panel 116. It should be noted that a preview 118 generated based on applied materials of the digital content and a main editing scene panel 114 run in isolation from each other.

At block 204, select a first material is selected from a material library, the first material not having been applied to the digital content. Referring to FIG. 1B, the terminal device may select, from a material library 110, a material that has not been applied to the digital content, for example, a wearing hat effect 112.

At block 206, in response to the selecting, display in the editing interface a first preview effect of the digital content with the first material 112 applied. Referring to FIG. 1B, a user may select a material from the material library 110, for example, a wearing hat effect 112. By applying the first material on the preview 118 of the digital content, a preview effect 120 of the first material combined with the applied materials of the digital content is displayed. Exemplarily, by applying the wearing hat effect on the preview 118 of the digital content, a preview effect 120 of a portrait wearing a hat is displayed.

In some embodiments, to help the user create, the user may be prompted whether the first material matches the digital content based on scene information collected from the digital content and the first preview effect. The scene information may include at least one of attribute information, object information, and geometric information. The scene information included in the digital content may be acquired based on the main editing scene panel 114, and the scene information included in the preview 120 of the portrait wearing the hat may be acquired based on the preview panel 116, where the scene information may include at least one of the attribute information, the object information, and the geometric information. Based on the above scene information, it is determined whether the wearing hat effect is suitable for the portrait, and the user is prompted whether the wearing hat effect matches the portrait.

In some embodiments, it is determined whether the first material matches the digital content based on the attribute information collected from the digital content and the first preview effect, where the attribute information includes at least one of color, material, and illumination. The attribute information included in the digital content may be acquired based on the main editing scene panel 114, and exemplarily, at least one of the color, the material, and the illumination of the digital content may be acquired. The attribute information included in the preview 120 of the portrait wearing the hat may be acquired based on the preview panel 116, and exemplarily, at least one of the color, the material, and the illumination included in the preview 120 of the portrait wearing the hat may be acquired. Based on the above attribute information, it is determined whether the wearing hat effect is suitable for the portrait, and the user is prompted whether the wearing hat effect matches the portrait.

In some embodiments, it is determined, based on the object information collected from the digital content and the first preview effect, that the digital content includes at least one object that is duplicated with the first material, and in response to determining the at least one object, it is determined that the first material does not match the digital content. The object information included in the digital content, for example, the portrait, may be acquired based on the main editing scene panel 114. The object information included in the preview 120 of the portrait wearing the hat, for example, the portrait and the hat, may be acquired from the preview panel 116. Based on the above object information, it is determined that the wearing hat effect is suitable for the portrait, and the user is prompted that the wearing hat effect matches the portrait. In some embodiments, when the object information included in the digital content includes the portrait and the hat, that is, the object information extracted from the digital content and the object information extracted from the first preview effect both include the hat, it is determined that the digital content has an object that is duplicated with the first material. In response to determining the object, it is determined that the first material does not match the digital content, and the user is prompted that the wearing hat effect does not match the portrait.

In some embodiments, sizes and positions of objects included in the digital content and the first preview effect are determined based on the geometric information collected from the digital content and the first preview effect, and based on the sizes and positions, it is determined that the first material matches the digital content. Geometric information of the objects included in the digital content, for example, a size and a position of the portrait, may be acquired based on the main editing scene panel 114. The geometric information of the objects included in the preview 120 of the portrait wearing the hat, for example, a size and a position of the hat, may be acquired from the preview panel 116. Based on the above geometric information, it is determined whether the wearing hat effect matches the portrait.

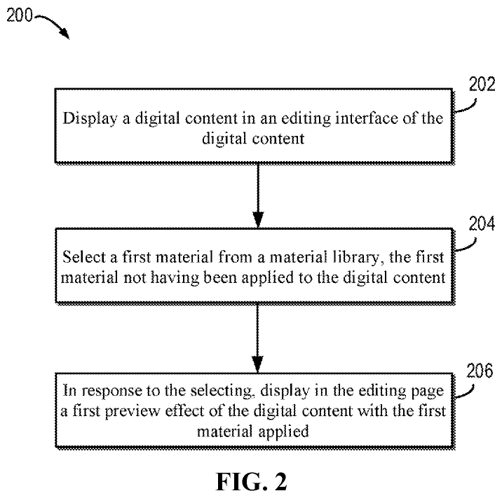

FIG. 3 shows a flowchart of a method 300 for rendering and generating a preview effect according to some embodiments of the present disclosure. In some embodiments, a terminal device may perform the method 300 in response to a user selecting a material in a material library 110. In some implementations, the method 300 is repeatedly performed whenever the user re-selects a material in the material library 110.

At block 302, the terminal device performs scene preparation. The scene preparation includes block 304 and block 306. At block 304, the terminal device performs memory copying of the scene, and at block 306, the terminal device registers a corresponding resource database. In some embodiments, at block 304, in response to the user selecting the material, the terminal device may copy data included in digital content in a main editing scene into the memory to generate a copy of the data of the digital content. Based on the generated copy of the data of the digital content, a preview of the digital content that runs in isolation from the digital content in the main editing scene is created. In some embodiments, at block 306, a resource database corresponding to the digital content in the main editing scene is registered, where the resource database is bound to a local folder, and the resource database is deployed in isolation from the main editing scene, and the data included in the resource database is completely isolated from the data in the main editing scene.

At block 308, the terminal device loads and imports the material. Loading and importing the material includes block 310 and block 312. At block 310, the terminal device generates a memory object, and at block 312, the terminal device creates an object in the preview. In some embodiments, at block 310, in response to the first material being selected from the material library, data included in the first material is parsed. Based on the parsed data included in the first material, a memory object corresponding to the first material is generated. Referring to FIG. 1B, in response to the wearing hat effect being selected from the material library 110, data included in the material of the wearing hat effect is parsed, and a memory object corresponding to the wearing hat effect is generated. In some embodiments, at block 312, the terminal device creates an object of the first material in the preview of the digital content based on the generated memory object. Referring to FIG. 1B, based on the generated memory object, an object corresponding to the first material, that is, a hat, is created in the preview panel 116, and the hat is displayed in the preview panel 116.

At block 314, the terminal device performs preview exporting and format conversion. The preview exporting and format conversion includes block 316 and block 318. At block 316, data required for the preview is extracted, and at block 318, a data format is determined based on a rendering engine. In some embodiments, at block 316, the terminal device may extract attribute information required for generating the preview effect based on an engine format of the rendering engine, where the attribute information may include at least one of color, material, and illumination. In some embodiments, at block 318, the data format is determined based on the rendering engine, where the rendering engine may support fast loading and rendering, and the extracted attribute information is stored based on the engine format of the rendering engine.

At block 320, the terminal device performing loading and rendering. The loading and rendering includes block 322 and block 324. At block 322, the data required for the preview is parsed, and at block 324, the preview effect is generated by rendering. In some embodiments, at block 322, the terminal device parses the stored attribute information, and exemplarily, parses the attribute information stored based on the engine format. At block 324, in some embodiments, the preview effect is rendered and generated based on the parsed attribute information. Referring to FIG. 1B, based on the parsed attribute information, the preview effect of the portrait wearing the hat in the preview panel 116 is generated by rendering.

The exemplary embodiments described above with reference to FIGS. 1 to 3 provide the method for generating the preview corresponding to the digital content based on the digital content of the main editing scene and displaying the preview effect of the selected material superimposed based on the preview. Compared with the prior art, the present disclosure provides an advantage in that a user may view, in real time, a preview display effect of the digital content with a material applied, without affecting the main editing scene. In addition, a matching perception method is further provided, in which the material added in the preview is compared with the digital content in the main editing scene to determine whether the added material matches the main editing scene and to prompt the user accordingly, thereby improving the efficiency and accuracy of digital content editing.

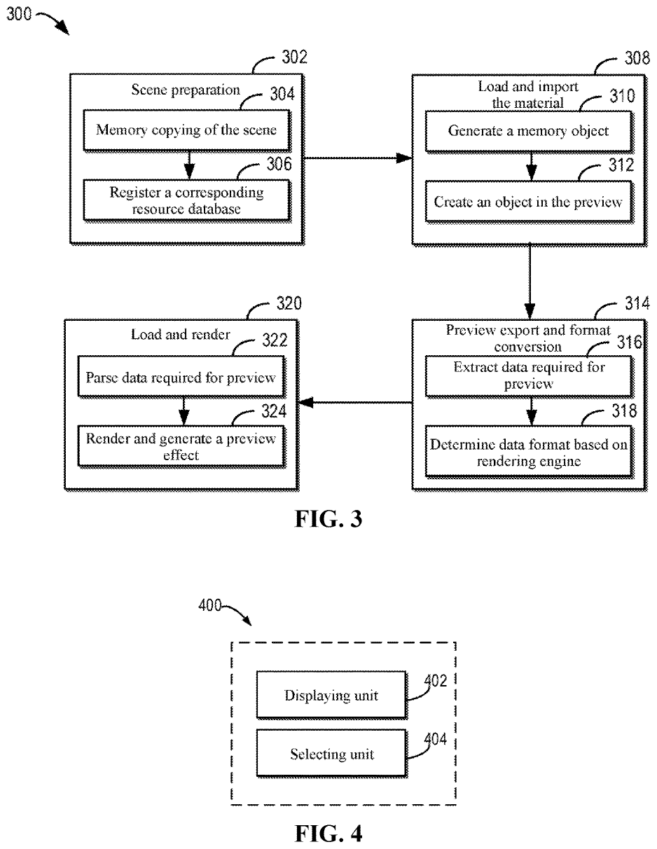

FIG. 4 shows a block diagram of an apparatus 400 for previewing digital content according to some embodiments of the present disclosure. As shown in FIG. 400, the apparatus 400 includes a displaying unit 402 configured to display the digital content in an editing interface of the digital content. The apparatus 400 further includes a selecting unit 404 configured to select a first material from a material library, the first material not having been applied to the digital content. The displaying unit 402 is further configured to, in response to the selecting, display in the editing interface a first preview effect of the digital content with the first material applied.

In some embodiments, the apparatus 400 may be further configured to: receive a touch on a blank area of the editing interface of the digital content; and restore displaying a preview of the digital content.

In some embodiments, the apparatus 400 may be further configured to: select a second material not having been applied to the digital content, the second material being different from the first material; and in response to the selecting the second material, display in the editing page a second preview effect of the digital content with the second material applied.

In some embodiments, the apparatus 400 may be further configured to: apply the first material to the digital content in response to a touch on a control associated with the first material.

In some embodiments, the apparatus 400 may be further configured to: configure the first material into a resource panel for editing the digital content.

In some embodiments, the apparatus 400 may be further configured to: prompt a user whether the first material matches the digital content based on scene information collected from the digital content and the first preview effect, the scene information including at least one of attribute information, object information, and geometric information.

In some embodiments, the apparatus 400 may be further configured to: determine whether the first material matches the digital content based on the attribute information collected from the digital content and the first preview effect, the attribute information including at least one of color, material, and illumination.

In some embodiments, the apparatus 400 may be further configured to: determine, based on the object information collected from the digital content and the first preview effect, that the digital content includes at least one object that is duplicated with the first material; and determine that the first material does not match the digital content in response to determining the at least one object.

In some embodiments, the apparatus 400 may be further configured to: determine sizes and positions of objects included in the digital content and the first preview effect based on the geometric information collected from the digital content and the first preview effect; and determine that the first material matches the digital content based on the sizes and the positions.

In some embodiments, the preview displaying unit 402 may be further configured to: generate, in a memory a copy of data of the digital content; and create, based on the copy of the data of the digital content, the preview of the digital content that runs in isolation from the digital content.

In some embodiments, the preview displaying unit 402 may be further configured to: register a resource database corresponding to the data of the digital content, where the resource database is bound to a local file, and the resource database is deployed in isolation from the data of the digital content.

In some embodiments, the preview displaying unit 402 may be further configured to: parse data included in the first material; generate a memory object corresponding to the first material based on the parsed data included in the first material; and create an object of the first material in the preview of the digital content based on the memory object.

In some embodiments, the preview displaying unit 402 may be further configured to: extract, based on an engine format of a rendering engine, attribute information required for generating the first preview effect based on an engine format of a rendering engine; and store the attribute information based on the engine format.

In some embodiments, the preview displaying unit 402 may be further configured to: parse the stored attribute information; and generate the first preview effect by rendering based on the parsed attribute information.

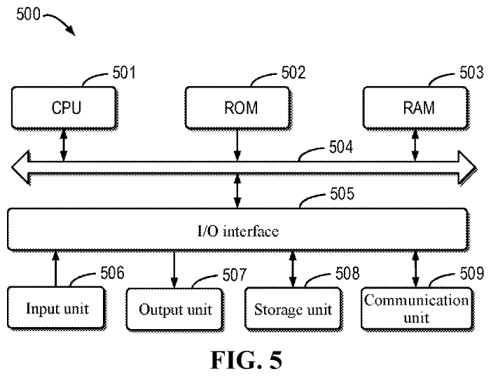

FIG. 5 shows a block diagram of a device 500 capable of implementing multiple embodiments of the present disclosure. As shown in FIG. 5, the device 500 includes a central processing unit (CPU) and/or a graphics processing unit (GPU) 501, which may perform various appropriate postures and processing based on computer program instructions stored in a read-only memory (ROM) 502 or computer program instructions loaded from a storage unit 508 into a random access memory (RAM) 503. In the RAM 503, various programs and data required for the operation of the device 500 may also be stored. The CPU/GPU 501, the ROM 502, and the RAM 503 are connected to each other through a bus 504. An input/output (I/O) interface 505 is also connected to the bus 504. Although not shown in FIG. 5, the device 500 may also include a coprocessor.

Multiple components in the device 500 are connected to the I/O interface 505, including: an input unit 506, such as a keyboard, a mouse, etc.; an output unit 507, such as various types of displays, speakers, etc.; the storage unit 508, such as a magnetic disk, an optical disc, etc.; and a communication unit 509, such as a network card, a modem, a wireless communication transceiver, etc. The communication unit 509 allows the device 500 to exchange information/data with other devices through a computer network such as the Internet and/or various telecommunication networks.

Each method or process described above may be performed by the CPU/GPU 501. For example, in some embodiments, the method may be implemented as a computer software program, which is tangibly contained in a machine-readable medium, such as the storage unit 508. In some embodiments, a portion or an entirety of the computer program may be loaded and/or installed into the device 500 via the ROM 502 and/or the communication unit 509. When the computer program is loaded into the RAM 503 and executed by the CPU/GPU 501, one or more steps or postures in the method or process described above may be performed.

In some embodiments, the methods and processes described above may be implemented as a computer program product. The computer program product may include a computer-readable storage medium having computer-readable program instructions thereon for performing various aspects of the present disclosure.

The computer-readable storage medium may be a tangible device that may hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanically encoded device, such as a punched card or a raised structure in a groove with instructions stored thereon, and any suitable combination of the above. The computer-readable storage medium used herein is not interpreted as an instantaneous signal itself, such as a radio wave or other freely propagating electromagnetic waves, an electromagnetic wave propagating through a waveguide or other transmission media (for example, a light pulse through an optical fiber cable), or an electrical signal transmitted through a wire.

The computer-readable program instructions described herein may be downloaded from the computer-readable storage medium to various computing/processing devices, or downloaded to an external computer or an external storage device through a network, such as the Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network, and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, including an object-oriented programming language and a conventional procedural programming language. The computer-readable program instructions may be executed entirely on a user computer, partly on the user computer, as a stand-alone software package, partly on the user computer and partly on a remote computer, or entirely on the remote computer or a server. In the case of the remote computer, the remote computer may be connected to the user computer through any kind of network, including a local area network (LAN) or a wide area network (WAN), or it may be connected to an external computer (for example, connected by using Internet provided by an Internet service provider). In some embodiments, by using state information of the computer-readable program instructions to customize an electronic circuit, such as a programmable logic circuit, a field programmable gate array (FPGA) or a programmable logic array (PLA), the electronic circuit may execute the computer-readable program instructions, thereby implementing various aspects of the present disclosure.

These computer-readable program instructions may be provided to a processing unit of a general-purpose computer, a special-purpose computer, or other programmable data processing apparatus to produce a machine, so that these instructions, when executed by the processing unit of the computer or other programmable data processing apparatus, produce an apparatus for implementing a function/attitude specified in one or more blocks in the flowchart and/or the block diagram. These computer-readable program instructions may also be stored in the computer-readable storage medium, these instructions cause the computer, the programmable data processing apparatus, and/or other devices to work in a specific manner, and thus, the computer-readable medium storing the instructions includes a manufactured product, which includes instructions for implementing various aspects of the function/attitude specified in one or more blocks in the flowchart and/or the block diagram.

The computer-readable program instructions may also be loaded onto the computer, other programmable data processing apparatus, or other devices, so that a series of operation steps are performed on the computer, other programmable data processing apparatus, or other devices to produce a computer-implemented process, thereby causing the instructions executed on the computer, other programmable data processing apparatus, or other devices to implement the function/attitude specified in one or more blocks in the flowchart and/or the block diagram.

The flowchart and block diagram in the drawings show the possibly implemented architectures, functions, and operations of the device, the method, and the computer program product according to multiple embodiments of the present disclosure. In this regard, each block in the flowchart or block diagram may represent a module, program segment, or part of an instruction, which contains one or more executable instructions for implementing the specified logical function. In some alternative implementations, the functions marked in the block may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a special-purpose hardware-based system that executes a specified function or attitude, or may be implemented by a combination of special-purpose hardware and computer instructions.

The embodiments of the present disclosure have been described above, and the above description is exemplary, non-exhaustive, and not limited to the disclosed embodiments. Without departing from the scope and spirit of the described embodiments, many modifications and changes will be apparent to those of ordinary skill in the art. The terms used herein are chosen to best explain the principles of the embodiments, the practical applications or technical improvements to the technologies in the market, or to enable other those of ordinary skill in the art to understand the embodiments disclosed herein.

1. A method for previewing digital content, comprising:
displaying a digital content in an editing interface of the digital content;
selecting a first material from a material library, the first material not having been applied to the digital content; and
in response to the selecting, displaying, in the editing page, a first preview effect of the digital content with the first material applied.

2. The method of claim 1, further comprising:
receiving a touch on a blank area of the editing interface of the digital content; and
restoring displaying the digital content.

3. The method of claim 1, further comprising:
selecting, from the material library, a second material not having been applied to the digital content, the second material being different from the first material; and
in response to selecting the second material, displaying, in the editing page, a second preview effect of the digital content with the second material applied.

4. The method of claim 1, further comprising:
applying the first material to the digital content in response to a touch on a control associated with the first material.

5. The method of claim 4, wherein applying the first material to the digital content comprises:
configuring the first material into a resource panel for editing the digital content.

6. The method of claim 4, further comprising:
prompting a user whether the first material matches the digital content based on scene information collected from the digital content and the first preview effect, wherein the scene information comprises at least one of: attribute information, object information, and geometric information.

7. The method of claim 6, wherein prompting the user whether the first material matches the digital content comprises:
determining whether the first material matches the digital content based on the attribute information collected from the digital content and the first preview effect, the attribute information comprising at least one of color, material, and illumination.

8. The method of claim 6, wherein prompting the user whether the first material matches the digital content comprises:
determining, based on the object information collected from the digital content and the first preview effect, that the digital content comprises at least one object that is duplicated with the first material; and
determining that the first material does not match the digital content in response to determining the at least one object.

9. The method of claim 6, wherein prompting the user that the first material matches the digital content comprises:
determining sizes and positions of objects comprised in the digital content and the first preview effect based on the geometric information collected from the digital content and the first preview effect; and
determining that the first material matches the digital content based on the sizes and the positions.

10. The method of claim 1, wherein displaying the digital content comprises:
generating, in a memory, a copy of data of the digital content; and
creating, based on the copy of the data of the digital content, a preview of the digital content that runs in isolation from the digital content.

11. The method of claim 10, further comprising:
registering a resource database corresponding to the data of the digital content, wherein the resource database is bound to a local file, and the resource database is deployed in isolation from the data of the digital content.

12. The method of claim 1, wherein displaying the first preview effect of the digital content with the first material applied in the editing page comprises:
parsing data comprised in the first material;
generating a memory object corresponding to the first material based on the parsed data comprised in the first material; and
creating, based on the memory object, an object of the first material in the displayed digital content.

13. The method of claim 12, wherein displaying, in the editing page, the first preview effect of the digital content with the first material applied comprises:
extracting, based on an engine format of a rendering engine, attribute information required for generating the first preview effect; and
storing the attribute information based on the engine format.

14. The method of claim 13, further comprising:
parsing the stored attribute information; and
rendering and generating the first preview effect based on the parsed attribute information.

15. An electronic device, comprising:
a processor; and
a memory coupled with the processor, the memory having instructions stored thereon, wherein the instructions, when executed by the processor, cause the electronic device to perform a method comprising:
displaying a digital content in an editing interface of the digital content;
selecting a first material from a material library, the first material not having been applied to the digital content; and
in response to the selecting, displaying, in the editing page, a first preview effect of the digital content with the first material applied.

16. The electronic device of claim 15, the method further comprising:
receiving a touch on a blank area of the editing interface of the digital content; and
restoring displaying the digital content.

17. The electronic device of claim 15, the method further comprising:
selecting, from the material library, a second material not having been applied to the digital content, the second material being different from the first material; and
in response to selecting the second material, displaying, in the editing page, a second preview effect of the digital content with the second material applied.

18. The electronic device of claim 15, the method further comprising:
applying the first material to the digital content in response to a touch on a control associated with the first material.

19. The method of claim 18, wherein applying the first material to the digital content comprises:
configuring the first material into a resource panel for editing the digital content.

20. A non-transitory computer-readable storage medium having computer-executable instructions stored thereon, wherein the computer-executable instructions are executable by a processor to implement a method comprising:
displaying a digital content in an editing interface of the digital content;
selecting a first material from a material library, the first material not having been applied to the digital content; and
in response to the selecting, displaying, in the editing page, a first preview effect of the digital content with the first material applied.
